(19) United States
(12) Patent Application Publication
(10) Pub. No.: US 2012/0080538 A1
(43) Pub. Date: Apr. 5, 2012

(54) PLANT WATERING RING

(76) Inventors: Warren Tyler Reid, Chandlers Hill (AU); Tyler Robinson, Los Alamitos, CA (US)

(21) Appl. No.: 13/249,697

(22) Filed: Sep. 30, 2011

Related U.S. Application Data
(60) Provisional application No. 61/388,814, filed on Oct. 1, 2010.

(51) Int. Cl. A62C 31/22

(52) U.S. Cl. 239/276

(57) ABSTRACT

A plant watering device includes a hollow rigid member which is substantially ring-shaped but has a gap between opposite closed ends of the member, the member having a lower surface with a plurality of spaced holes for dispensing water out of the hollow interior chamber in the member. A plurality of removable peg-like legs are configured to engage mounting sleeves on the lower surface of the member at one end and to be embedded in the soil or other medium surrounding the plant at the opposite end. A hose connector protrudes outwards from the ring-shaped member and can be connected to a water supply hose so that water is supplied into the hollow ring and flows through the chamber and out through the dispensing holes.

### RELATED APPLICATION

The present application claims the benefit of co-pending U.S. provisional pat. App. Ser. No. 61/388,814, filed Oct. 1, 2010, the contents of which are incorporated herein by reference in their entirety.

### BACKGROUND

1. Field of the Invention

The present invention relates generally to irrigation or watering devices and is particularly concerned with a plant watering device for use in watering indoor or outdoor plants.

2. Related Art

Various types of drip irrigation devices, sprayers, and the like are known for irrigation purposes. Watering devices are also used for indoor plants. Soaker hoses have small openings so that, when connected to a water supply, water leaks out of the hose into the ground adjacent plants for watering purposes. Such hoses are sometimes threaded around plants and bushes. Sprayers are often inefficient and do not supply uniform amounts of water around a plant, so that the root system is not exposed to an even distribution of moisture.

Some ring-shaped or cylindrical watering devices are known, for example the plant watering device described in U.S. Pat. No. 5,212,905 of Philoctete in which a hollow cylindrical device completely surrounds a plant and has an internal reservoir connected to a water supply, as well as outlet holes adjacent the top of the cylinder which dispense water onto the area surrounding the plant. Continuous drip rings are also known for placing on the growing medium or soil surrounding a pant in a pot or container. Some prior watering rings are designed as large reservoirs to store quantities of water for slow release over time, and typically can hold several gallons of water.

### SUMMARY

Embodiments described herein provide for a plant watering device.

According to one embodiment, a multi-part watering device is provided which comprises a rigid, hollow member which is substantially ring-shaped, with a gap or opening in the ring between opposite closed ends of the member, and a plurality of peg-like legs configured for releasable engagement with a lower surface of the ring-shaped member, the legs having generally pointed ends for engagement in soil or growing medium surrounding one or more plants. The hollow member has an upper surface and a lower surface, the lower surface having a plurality of small holes spaced along its length between the ends of the member. The member also has an inlet or barbed connector configured for connection to a water hose, tubing or the like for connecting a supply of water or other fluid to the interior of the hollow-ring shaped member. The fluid may be water or a mixture of water and plant nutrients or fertilizer. The ring is designed to operate under pressure for continuous flow of water through the interior of the ring and out of the holes.

In one embodiment, the ring-shaped member has a flat upper surface and rounded or arcuate lower surface, and the lower surface has a plurality of downwardly facing mounting projections or sleeves configured for receiving the upper ends of the pegs or legs. The device may have three or more removable legs. The barbed connector may be located opposite the gap in the ring-shaped member, projecting away from the ring, for easy access by a user to attach a hose or the like.

Ring-shaped members may be provided in different diameters with legs of different lengths, for watering different sizes of indoor or outdoor plants or fitting different size plant pots.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a top perspective view of the separated parts of one embodiment of a plant watering device;

FIG. 2 is a bottom plan view of the ring-shaped watering member of the device of FIG. 1;

FIG. 3 is an enlarged cross-section on the lines 3-3 of FIGS. 2; and

FIG. 4 is a perspective view of the assembled watering device.

### DETAILED DESCRIPTION

Certain embodiments as disclosed herein provide for a plant watering device for substantially even plant watering.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

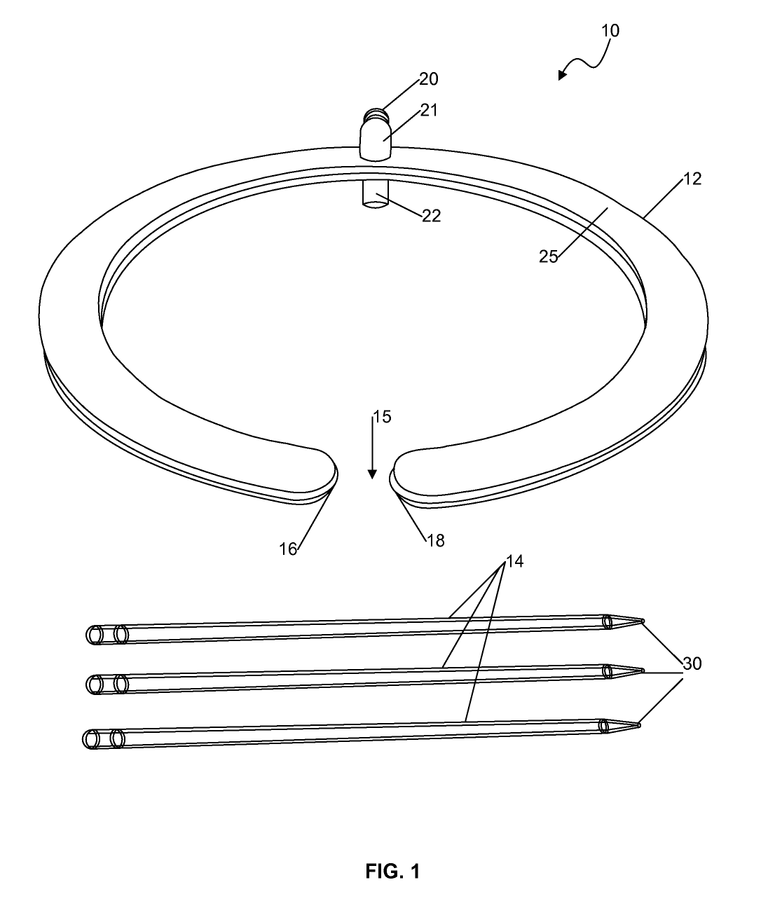

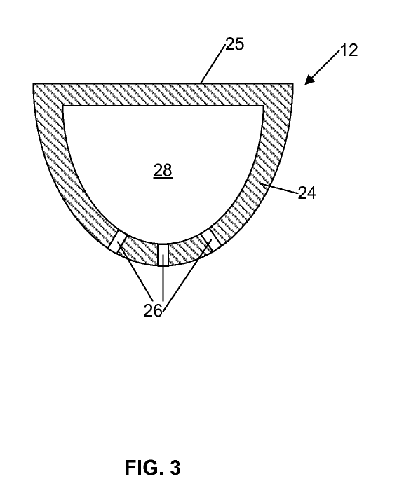

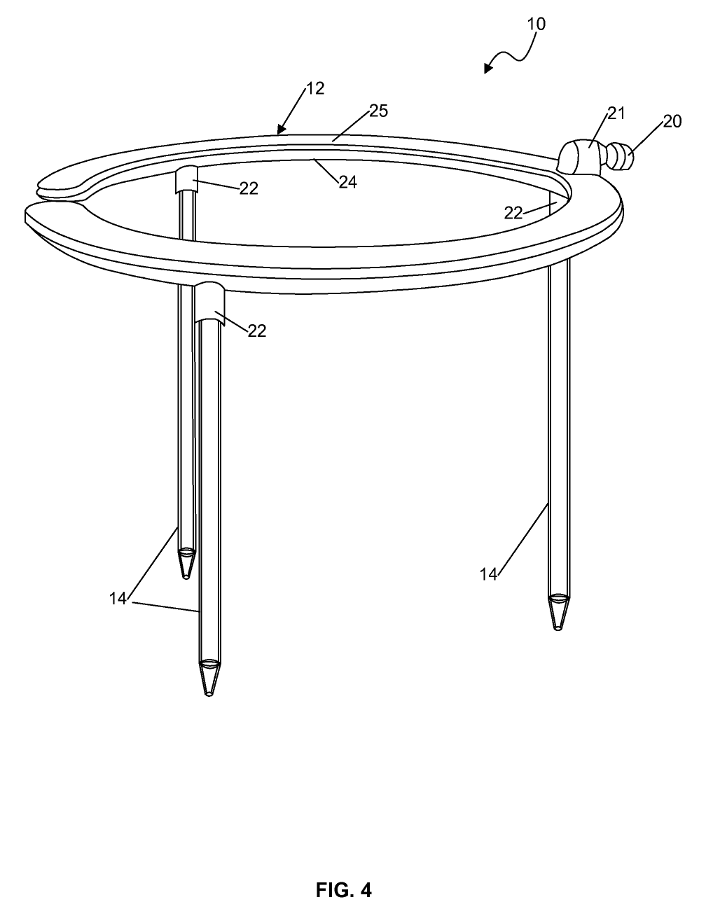

FIGS. 1 to 4 illustrate one embodiment of a multiple part plant watering device or apparatus 10. FIG. 1 illustrates the separated components of the watering device or apparatus, while FIG. 4 illustrated the parts assembled and ready for use. The apparatus comprises a rigid, substantially ring-shaped hollow member 12 and a plurality of peg-like legs 14 for supporting the member 12 at a location spaced above the ground and surrounding one or more plants. Hollow member 12 does not form a complete circle but has opposite closed ends 16, 18 spaced apart to form a relatively small gap 15 in the ring. As best illustrated in FIG. 3, the ring-like hollow member 12 has a flat upper surface 25 and an arcuate, convex lower surface 24 surrounding internal chamber 28. A plurality of holes 26 are spaced along the length of lower surface 24 for dispensing water from chamber 28 onto the ground or growing medium below the ring.

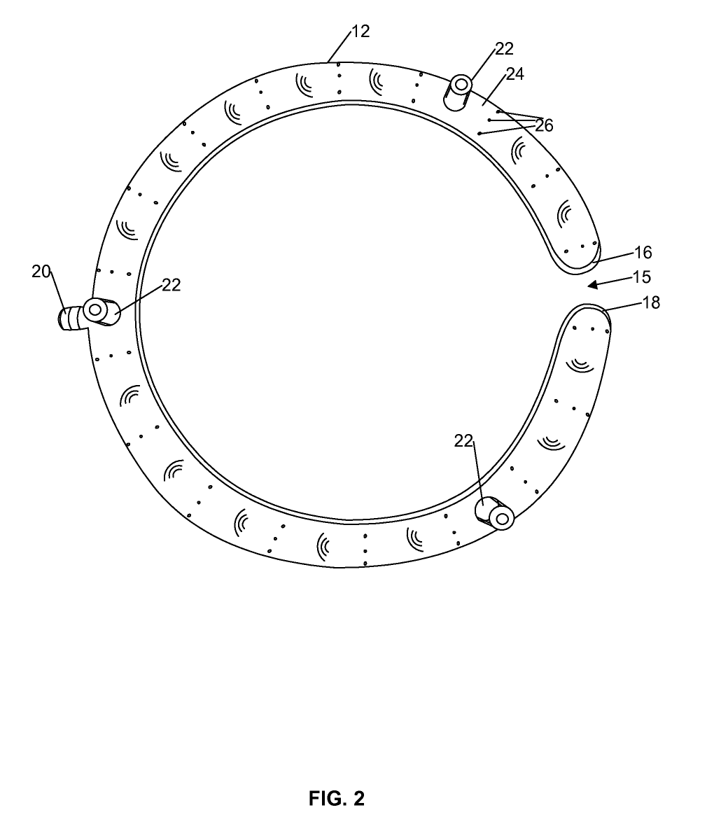

A barbed inlet or connector 20 for connection to a water supply hose projects from a raised inlet portion 21 on the upper surface 25 of the ring which communicates with chamber 28. Inlet 20 projects outwardly from the member 12 at a location substantially opposite gap 15. Evenly spaced hollow mounting projections or sleeves 22 for the legs project from arcuate lower surface 24 of the member, as illustrated in FIGS. 2 and 4. In the illustrated embodiment, three legs 14 and corresponding mounting sleeves 22 are provided, but four or more supporting legs and corresponding mounting sleeves may be provided in other embodiments, depending on the ring dimensions.

In one embodiment, the member 12 is molded in one piece from rigid plastic material or the like. In the illustrated embodiment, the holes 26 are provided in spaced groups of three, as best illustrated in FIG. 2, but other hole patterns may be provided in alternative embodiments.

Water or a mixture of water and other plant growing solutions is supplied to chamber 28 via inlet 20, and drips from the holes 26 onto the ground below. As seen in FIG. 3, some holes extend directly downwards while others are angled outwards to provide substantially even distribution of water to the ground or soil surrounding the plant.

As illustrated in FIG. 4, in order to assemble the device, the pegs or legs 14 are removably engaged at one end in the respective mounting sleeves 22. The opposite ends 30 of the legs are pointed so that they can be easily pushed into the ground or soil surrounding a plant or plants to be watered, either outdoors or in a pot, and this may be done before or after engaging the legs with the respective mounts in ring member 12. Once assembled as in FIG. 4, the legs support the watering ring at a location spaced above the ground or soil surrounding one or more plants. Gap 15 allows the ring to be installed around the stem of a growing plant. Water or irrigation fluid supply tubing or hose (not illustrated) is then attached to the inlet or barbed connector 20, and the opposite end of the tubing is attached to a tap or water pump to pump water or mixtures of water and other additives through the chamber and out of the holes 26.

The device can be made in a variety of different sizes for small and large plant applications. In one example, the ring defines the majority of the circumference of a circle which is approximately 11⅝ inches in diameter and the assembled device is around twelve inches tall when the ring is mounted on the legs, as illustrated in FIG. 4. In another embodiment, the ring diameter is around six inches and the assembled device is around six inches tall. Other ring dimensions and diameters may be used in alternative embodiments, depending on the size of the plant or plants to be watered. Ring-shaped or C-shaped hollow members of different diameters may be provided for different indoor and outdoor plant watering purposes, with the diameters for indoor plants designed to fit different standard plant pot sizes. The ring-shaped member may be of different, non-circular shapes in alternative embodiments, such as oval, elliptical, and the like. Pegs or legs 14 may be provided in different lengths.

The water or fluid inlet may be a half inch barbed inlet for half inch diameter tubing, or may be a garden hose fitting or other type of connector, or a barbed inlet of different dimensions. In the illustrated embodiment, eighteen spaced groups or radially extending rows of three dispensing holes are provided at spaced intervals along the ring member, at a spacing of around two inches apart for a ring diameter of around 11.5 inches. Different numbers of holes and hole patterns may be provided in other embodiments to accommodate different watering requirements. The gap in the ring shaped member allows the grower to install the ring around a plant which is already growing, or to remove the ring for cleaning or replacement purposes during plant growth. The design of the ring-shaped member and the plural water dispensing holes allows the grower to adjust the water flow into the ring in order to produce a desired even flow of water for complete saturation of the soil or growing medium surrounding the plant, so moisture is provided substantially evenly to all root areas. The ring member is a flow-through watering device designed to operate under pressure with continuous flow of water through the chamber and out through the holes, and is not a water storage device.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

We claim:

1. A plant watering device, comprising:
a rigid, hollow, generally ring-shaped member with opposite, closed ends which are spaced apart to form a gap in the ring shape, the member having an internal chamber extending between the ends, an upper surface and a lower surface;
a plurality of legs each having a first end configured for releasable engagement with the lower face of the ring-shaped member at spaced intervals around the member and a second, substantially pointed end configured for engagement in soil or growing medium surrounding one or more plants;
the lower surface having a plurality of small holes;
the ring-shaped member having at least one inlet connected to the chamber and configured for connection to a fluid supply, whereby fluid flows from the inlet through the internal chamber and out of the holes.

2. The device of claim 1, wherein the ring-shaped member has a flat upper surface.

3. The device of claim 2, wherein the lower surface is an arcuate, convex surface.

4. The device of claim 1, wherein lower surface has a plurality of spaced, downwardly facing mounting projections configured for receiving the upper ends of the legs.

5. The device of claim 1, wherein at least three legs are configured for releasable engagement at spaced intervals around the ring.

6. The device of claim 1, wherein the inlet comprises a barbed connector configured for attachment to a water hose.

7. The device of claim 1, wherein the inlet is positioned opposite to the gap in the ring-shaped member.

8. The device of claim 7, wherein the inlet is raised above the upper surface of the ring-shaped member and extends outwardly from the member.

10. The device of claim 1, wherein the ring-shaped member extends around a major portion of the periphery of a circle.

11. The device of claim 10, wherein the diameter of the circle is at least six inches.

12. The device of claim 10, wherein the length of the legs is approximately equal to the diameter of the ring.

13. The device of claim 10, wherein the diameter of the circle is around 11.5 inches.

14. The device of claim 13, wherein the length of the legs is around 12 inches.

15. The device of claim 1, wherein the holes are located in spaced groups around the ring, each group comprising at least one row of multiple spaced holes.

16. The device of claim 15, wherein each row extends in a line extending transversely across the lower surface of the ring.
